(19) United States
(12) Patent Application Publication
(10) Pub. No.: US 2024/0395261 A1
(43) Pub. Date: Nov. 28, 2024

(54) VIRTUAL ASSISTANT WITH ADAPTIVE PERSONALITY TRAITS

(71) Applicants: Xiaomin Li, Belmont, CA (US); Yi Xu, Belmont, CA (US)

(72) Inventors: Xiaomin Li, Belmont, CA (US); Yi Xu, Belmont, CA (US)

(21) Appl. No.: 18/661,484

(22) Filed: May 10, 2024

Related U.S. Application Data
(60) Provisional application No. 63/503,776, filed on May 23, 2023.

(51) Int. Cl. G10L 17/22; G06V 20/50; G06V 40/10; G10L 13/02; G10L 17/06

(52) U.S. Cl. CPC G10L 17/22; G06V 20/50; G06V 40/10; G10L 13/02; G10L 17/06

(57) ABSTRACT

This disclosure provides methods, devices, and systems for implementing virtual assistants. The present implementations more specifically relate to virtual assistants with adaptive personality traits. In some aspects, a virtual assistant may store long-term notes about a user. The long-term notes may include information derived from a history of past interactions between the virtual assistant and the user. In some implementations, the long-term notes may include one or more personality traits adopted by the virtual assistant based on the past interactions. The personality traits (and other long-term notes) may be incorporated into prompts sent by the virtual assistant to a natural language processor (NLP) so that the learned personality of the virtual assistant is reflected in the responses returned by the NLP.

### CROSS-REFERENCE TO RELATED APPLICATION

This application claims priority and benefit under 35 USC § 119 (e) to U.S. Provisional Patent Application No. 63/503,776, filed on May 23, 2023, which is incorporated herein by reference in its entirety.

### TECHNICAL FIELD

The present implementations relate generally to intelligent virtual assistants, and specifically to virtual assistants with adaptive personality traits.

### BACKGROUND OF RELATED ART

Intelligent virtual assistants (also referred to simply as “virtual assistants”) are devices that can interact with a user, for example, by listening and responding to the user's commands or queries. Example suitable queries may include, among other examples, requests for information (such as recipes, instructions, or directions), to play back media content (such as music, videos, or audiobooks), or to control various devices in a home or office environment (such as lights, thermostats, garage doors, or other home automation devices). Interactions between a user and a virtual assistant are generally initiated by the user. For example, some existing virtual assistants listen for a predetermined “trigger word” (or “wake word”) before conversing with the user.

Many virtual assistants rely on natural language processing to interpret user queries and generate suitable responses. For example, a virtual assistant may detect user speech and convert the speech into a sequence of input tokens (collectively referred to as a “prompt”) that can be processed by a natural language processor (NLP). The NLP infers or otherwise generates a sequence of output tokens (collectively referred to as a “completion”) based on the prompt and returns the completion to the virtual assistant. More specifically, the completion may include a response to the user's query. Advancements in natural language processing technology have resulted in NLPs that are capable of processing more complex queries and producing more dynamic responses. As NLPs continue to evolve, new virtual assistants may be needed to support some of the advanced natural language processing capabilities.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method performed by a controller for a virtual assistant (VA) system. The method includes assigning a set of personality traits to the VA system based on one or more interactions between the VA system and a user; receiving input data via one or more input sources associated with the VA system; generating a prompt based at least in part on the received input data and the set of personality traits assigned to the VA system; and inferring a response to the prompt based on a natural language processing (NLP) model.

Another innovative aspect of the subject matter of this disclosure can be implemented in a controller for a VA system, including a processing system and a memory. The memory stores instructions that, when executed by the processing system, cause the controller to assign a set of personality traits to the VA system based on one or more interactions between the VA system and a user; receive input data via one or more input sources associated with the VA system; generate a prompt based at least in part on the received input data and the set of personality traits assigned to the VA system; and infer a response to the prompt based on an NLP model.

### BRIEF DESCRIPTION OF THE DRAWINGS

The present embodiments are illustrated by way of example and are not intended to be limited by the figures of the accompanying drawings.

FIG. 1 shows an example virtual assistant environment.

FIG. 2 shows a block diagram of an example virtual assistant (VA) system, according to some implementations.

FIG. 3 shows another block diagram of an example VA system, according to some implementations.

FIG. 4 shows an example natural language processing prompt, according to some implementations.

FIG. 5 shows an example implementation of a virtual assistant with adaptive personality traits, according to some implementations.

FIG. 6 shows a block diagram of an example controller for a VA system, according to some implementations.

FIG. 7 shows an illustrative flowchart depicting an example operation performed by a VA system, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, many virtual assistants rely on natural language processing to interpret user queries and generate suitable responses. For example, a virtual assistant may detect user speech and convert the speech into a sequence of input tokens (collectively referred to as a “prompt”) that can be processed by a natural language processor (NLP). The NLP infers or otherwise generates a sequence of output tokens (collectively referred to as a “completion”) based on the prompt and returns the completion to the virtual assistant. More specifically, the completion may include a response to the user's query. Advancements in natural language processing technology have resulted in NLPs that are capable of processing more complex queries and producing more dynamic responses. For example, some NLPs can tune various characteristics of their responses (such as conciseness of speech) to user preferences indicated in the query.

However, natural language processing models (also referred to as large language models or “LLMs”) have no memory of past queries. In other words, the completion generated by an NLP at any given time depends only on the prompt that was provided as input to the NLP at that time. As a result, many existing virtual assistants often sound “robotic” or otherwise devoid of personality. For example, because an NLP has no memory of how a user prefers to be spoken to, responses generated by the NLP may exhibit unwanted characteristics (such as speech that is too concise or verbose) unless the user expressly dictates a preferred characteristic with each query. Aspects of the present disclosure recognize that by storing long-term “notes” about its users, a virtual assistant can adopt various personality traits based on the preferences of the users. As used herein, the term “personality trait” refers to any tunable characteristic of how a virtual assistant responds or otherwise interacts with a user. Example suitable personality traits may include verbosity, agreeableness, optimism, openness, and extraversion, among other examples.

Various aspects relate generally to virtual assistants, and more particularly, to virtual assistants with adaptive personality traits. In some aspects, a virtual assistant may store long-term notes about a user. The long-term notes may include information derived from a history of past interactions between the virtual assistant and the user. In some implementations, the long-term notes may include one or more personality traits adopted by the virtual assistant based on the past interactions. The personality traits (and other long-term notes) may be incorporated into prompts sent by the virtual assistant to an NLP (also referred to as “NLP prompts”) so that the learned personality of the virtual assistant is reflected in the responses returned by the NLP.

In some implementations, the virtual assistant may generate NLP prompts having multiple modalities. For example, the virtual assistant may combine input data from different types of sensors (such as cameras and microphones) into the same NLP prompt. As a result, the responses produced by the NLP may address not only what the user is saying, but also what the user is doing. Still further, in some implementations, the virtual assistant may generate NLP prompts based, at least in part, on event information received from a task scheduler. For example, the task scheduler may be a virtual calendar or appointment book with a list of tasks that the user must complete at (or by) specific scheduled times.

Particular implementations of the subject matter described in this disclosure can be implemented to realize one or more of the following potential advantages. By storing long-term notes about a user, aspects of the present disclosure can dynamically tune the characteristics of responses generated by an NLP to the preferences of the user. As a result, the virtual assistant of the present implementations can provide an improved user experience, for example, by developing a personality that is well-suited to the preferences of the user. Unlike existing virtual assistants that respond to user queries in the same robotic manner, the virtual assistant of the present implements can grow and adapt its personality to the whims of the user.

By generating multimodal NLP prompts, aspects of the present disclosure can add new dimensions to the virtual assistant's responses to user inputs. For example, a user may command the virtual assistant to “follow me” and the virtual assistant may respond by following the movements of the user. Further, by incorporating schedule-based tasks into NLP prompts, aspects of the present disclosure can proactively initiate interactions with the user. For example, if a user has music lessons at a scheduled time, the virtual assistant can proactively remind the user “it's time to go to your music lessons” before the scheduled time (and in the absence of any user input). In some aspects, the schedule-based tasks may periodically trigger the virtual assistant to engage the user. For example, the virtual assistant can be configured to initiate an interaction with the user every few minutes (such as by communicating with the user or following the user).

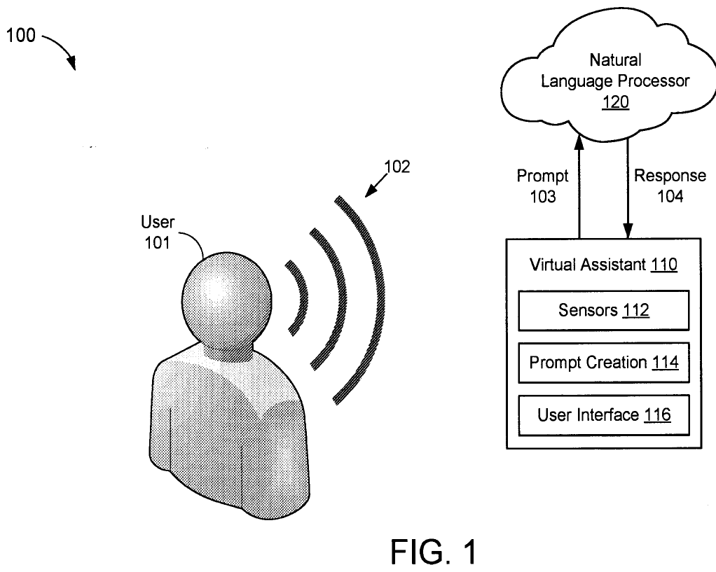

FIG. 1 shows an example virtual assistant environment 100. The environment 100 includes a user 101, a virtual assistant 110, and a natural language processor (NLP) 120. The virtual assistant 110 is configured to assist the user 101 with various tasks via hands-free operation. In some aspects, the virtual assistant 110 may listen and respond to the user's speech 102. For example, the speech 102 may include instructions or queries by the user 101.

The virtual assistant 110 includes one or more sensors 112, a prompt creation component 114, and a user interface 116. The sensors 112 may include any suitable sensor technology that can be used to detect changes in a surrounding environment. Example suitable sensor technologies may include audio and visual sensor technologies, among other examples. In some implementations, the sensors 112 may include one or more microphones that are configured to detect sounds (such as the user speech 102) propagating through the environment. For example, the microphones may convert the detected sounds to an electrical signal (also referred to as an “audio signal”) representative of the acoustic waveform.

The prompt creation component 114 is configured to generate a prompt 103 based on environmental changes detected by the sensors 112. For example, the prompt 103 may include a sequence of tokens that are suitable for processing by the NLP 120. In some implementations, the virtual assistant 110 may perform a speech-to-text conversion operation that transcribes the speech 102 into textual content, and the prompt creation component 114 may encode the text into a sequence of tokens that can be processed by the NLP 120. In some aspects, the tokens may be further mapped to a sequence of vectors (also referred to as “embeddings”) which provide semantic information about the words represented in the prompt 103.

The NLP 120 is configured to generate a response 104 based on the prompt 103. For example, the response 104 may include a completion (or a sequence of tokens) associated with the prompt 103. More specifically, the completion represents a string of words that answers or otherwise responds to the user's query. In some implementations, the NLP 120 may generate the response 104 based on a machine learning model. Machine learning is a technique for improving the ability of a computer system or application to perform a specific task. During a training phase, a machine learning system is provided with multiple “answers” and a large volume of raw input data. The machine learning system analyzes the input data to “learn” a set of rules (also referred to as the machine learning “model”) that can be used to map the input data to the answers. During an inferencing phase, the machine learning system uses the trained model to infer answers from new input data.

Deep learning is a particular form of machine learning in which the model being trained is a multi-layer neural network. Deep learning architectures are often referred to as artificial neural networks because of the manner in which information is processed (similar to a biological nervous system). For example, each layer of the deep learning architecture is formed by a number of artificial neurons. The neurons are interconnected across the various layers so that input data may be passed from one layer to another. More specifically, each layer of neurons may perform a different set of transformations on the input data (or the outputs from the previous layer) that ultimately results in a desired inference. Example suitable neural networks for natural language processing include recurrent neural networks (RNNs), long short-term memory (LSTM) networks, and transformers, among other examples.

The accuracy of the inferences generally depends on the size of the neural network. More specifically, larger neural network models tend to produce more accurate inferencing results than smaller neural network models. As such, NLPs are often implemented by computing platforms (such as servers) with large memory and processing resources. In some aspects, the NLP 120 may be hosted on a server remote to the virtual assistant 110. In such aspects, the virtual assistant 110 may transmit the prompt 103 to the NLP 120 over a (wired or wireless) communication channel and may receive the response 104 from the NLP 120 over the same (or different) communication channel. In some implementations, the natural language processing model may be dynamically updated or fine-tuned (such as at the end of every 24-hour cycle) to produce more accurate inferences based on the prompts 103 received by the NLP 120.

The user interface 116 provides an interface through which the virtual assistant 110 can output or otherwise manifest the response 104 to the user 101. Example suitable user interfaces may include media output devices (such as speakers or displays), electronic motors or actuators (such as to move or propel the virtual assistant 110), and data communication interfaces (such as to communicate with various smart home devices or appliances), among other examples. In some implementations, the virtual assistant 110 may decode the response 104 (or completion) as words or text and perform a text-to-speech conversion operation that converts the decoded text to an audio signal. In such implementations, the user interface 116 may include one or more speakers that are configured to output the audio signal as acoustic waves.

For example, the user 101 may query the virtual assistant 110, “What is the capital of California?” The virtual assistant 110 may detect the query in the user speech 102 (such as via the sensors 112) and convert the query into a tokenized prompt 103 (such as via the prompt creation component 114). The virtual assistant 110 transmits the prompt 103 to the NLP 120, which infers a tokenized response 104 that answers the query. An example suitable response may include, “The capital of California is Sacramento.” The virtual assistant 110 may recover the text associated with the response 104 and output the text as an audio signal (such as via the user interface 116).

As another example, the user 101 may query the virtual assistant 110, “What is the capital of California? Answer as concisely as possible.” The virtual assistant 110 may detect the query in the user speech 102 (such as via the sensors 112) and convert the query into a tokenized prompt 103 (such as via the prompt creation component 114). The virtual assistant 110 transmits the prompt 103 to the NLP 120, which infers a tokenized response 104 that answers the query. An example suitable response may include, “Sacramento.” The virtual assistant 110 may decode the text associated with the response 104 and output the text as an audio signal (such as via the user interface 116).

As described above, existing natural language processing models have no memory of past queries. Thus, the response 104 generated by the NLP 120 depends only on the prompt 103 that was provided as input to the NLP 120 (to infer the response 104). As a result, many existing virtual assistants often sound robotic or otherwise devoid of personality. For example, if the virtual assistant 110 queries the NLP 120, “What is the capital of California? Answer as concisely as possible,” the NLP 120 may respond, “Sacramento.” However, if the virtual assistant 110 subsequently queries the NLP 120, “What is the capital of New York?” the NLP 120 may respond, “The capital of New York is Albany.” In other words, the NLP 120 does not remember that the user 101 may prefer concise responses.

Aspects of the present disclosure recognize that the virtual assistant 110 may determine the preferences of the user 101 based on prior interactions with the user 101. For example, the virtual assistant 110 may determine that the user 101 prefers concise responses to user queries based on receiving an instruction from the user 101 to “answer as concisely as possible.” Moreover, the virtual assistant 110 may include memory resources that can be used to store a history or record of such user preferences. Thus, in some aspects, the virtual assistant 110 may use such knowledge to adopt or develop a personality that is well-suited to the preferences of the user 101. For example, the virtual assistant 110 may incorporate known information about the user 101 into the prompt 103 so that various characteristics of the response 104 are tailored to the preferences of the user 101.

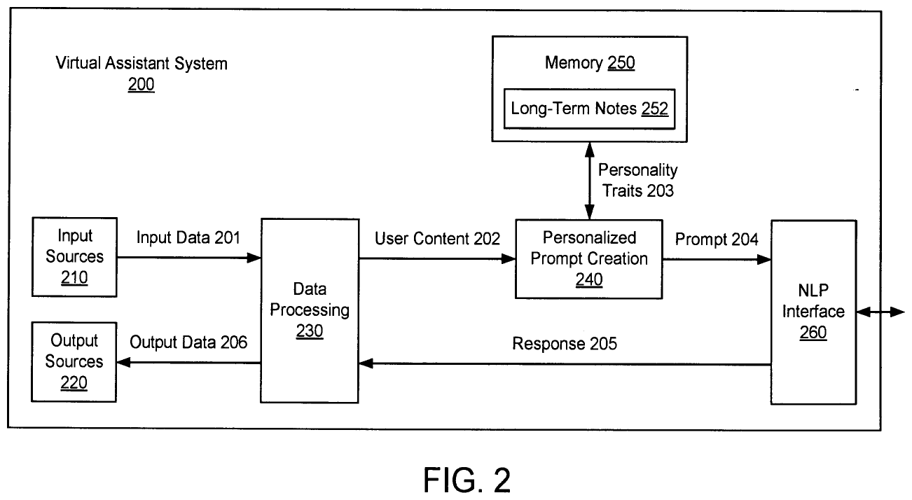

FIG. 2 shows a block diagram of an example virtual assistant (VA) system 200, according to some implementations. The VA system 200 is configured to assist a user with various tasks via hands-free operation, for example, by responding to the user's instructions or queries. More specifically, the VA system 200 may be configured to communicate with an NLP backend (not shown for simplicity) to determine the responses to the user instructions or queries. In some implementations, the VA system 200 may be one example of the virtual assistant 110 of FIG. 1.

The VA system 200 includes one or more input sources 210, one or more output sources 220, a data processing component 230, a personalized prompt creation (PPC) component 240, a memory 250, and an NLP interface 260. The input sources 210 are configured to produce input data 201 based on activity or information associated with the user. In some implementations, the input sources 210 may include the sensors 112 of FIG. 1. For example, the input sources 210 may include any suitable sensor technology that can be used to detect changes in a surrounding environment (such as cameras, motion sensors, or microphones). Thus, the input data 201 may include sensor data indicating the changes detected by the sensors.

The data processing component 230 is configured to produce user content 202 based on the input data 201. The user content 202 may include any information or content that can be converted to, or otherwise included in, an NLP prompt. Example suitable user content may include speech transcriptions, images, video, raw audio data, user identification information, and contextual information about the surrounding environment, among other examples. In some implementations, the data processing component 230 may perform a speech-to-text conversion operation that transcribes user speech in the input data 201 into text and also may determine whether the user speech matches a known voice identifier (ID). In such implementations, the user content 202 may include the transcribed text and the matching voice ID (if any) associated with the user speech.

The PPC component 240 is configured to generate a prompt 204 based, at least in part, on the user content 202. For example, the PPC component 240 may encode the text transcription of the user speech into a sequence of tokens that can be processed by the NLP backend. In some implementations, the PPC component 240 may further map the tokens to word embeddings as part of the prompt encoding process. In some aspects, the PPC component 240 may personalize the prompt 204 based on known information about the user. For example, the memory 250 may be configured to store long-term notes 252 about one or more users associated with the VA system 200. The long-term notes 252 may include information derived from a history of past interactions between the VA system 200 and the one or more users. In some implementations, the history of past interactions may include all past interactions between the VA system 200 and the one or more users.

In some implementations, the long-term notes 252 may include one or more personality traits 203 adopted by the VA system 200 based on past interactions with a particular user. As used herein, the term “personality trait” may refer to any tunable characteristic of how the VA system 200 responds or otherwise interacts with a user. For example, if a user queries the VA system 200, “What is the capital of California? Answer as concisely as possible,” the VA system 200 may store a personality trait 203 (or long-term note 252) indicating that the user prefers concise responses. Other example suitable personality traits may include optimism, openness, agreeableness, and extraversion, among other examples.

In some aspects, the PPC component 240 may generate the prompt 204 based, at least in part, on one or more personality traits 203 associated with a user. For example, the PPC component 240 may detect a voice ID (or other user identification information) in the user content 202 and retrieve a set of personality traits 203, from the memory 250, that matches the voice ID of the user. In some implementations, the PPC component 240 may include or otherwise incorporate the matching personality traits 203 into the prompt 204. For example, if the user content 202 includes a user query, “What is the capital of New York?” and the memory 250 stores a personality trait 203 indicating that the user prefers concise responses, the PPC component 240 may add an instruction to “answer as concisely as possible” in the prompt 204. As a result, the query represented by the prompt 204 may be different than the original user query (such as the text included in the user content 202).

The NLP interface 260 is configured to transmit or output the prompt 204 to the NLP backend. For example, the NLP interface 260 may include an application programming interface (API) associated with the NLP backend or communications hardware that can transmit the prompt 204 to the NLP backend. The NLP backend may be any suitable NLP configured to generate a response 205 based on the prompt 204. In some implementations, the NLP backend may be one example of the NLP 120 of FIG. 1. For example, the response 205 may include a completion associated with the prompt 204. Thus, if the prompt 204 includes a user query, “What is the capital of New York?” and the PPC component 240 adds an instruction to “answer as concisely as possible,” based on the personality traits 203, an example suitable response 205 may include a tokenized representation of the text, “Albany.”

The NLP interface 260 receives the response 205 from the NLP backend and provides the response 205 to the data processing component 230. The data processing component 230 is further configured to produce output data 206 based on the received response 205. More specifically, the data processing component 230 may recover various outputs or instructions for responding to user queries or other information included in the input data 201. In some implementations, the data processing component 230 may decode or recover textual content included in the response 205 and perform a text-to-speech conversion operation that converts the decoded text to an audio signal. In such implementations, the output data 206 may include the audio signal recovered from the response 205.

The output sources 220 are configured to interact with the user based on the output data 206. In some implementations, the output sources 220 may be one example of the user interface 116 of FIG. 1. For example, the output sources 220 may include any suitable interface through which the VA system 200 can output or otherwise manifest responses to the changes detected by the input sources 210 (such as speakers, displays, motors, actuators, or data communication interfaces). In some implementations, the output sources 220 may include one or more speakers to output audio signals as acoustic waves. For example, the speakers may output the word, “Albany,” in response to the user query, “What is the capital of New York?”

Thus, by storing long-term notes 252 about one or more users, the VA system 200 can provide a more personalized user experience compared to existing virtual assistants. For example, unlike existing virtual assistants that sound robotic or otherwise devoid of personality, the VA system 200 can tailor the characteristics of its responses to any known preferences of the user. As a result, the user may perceive the VA system 200 as a sentient object that can grow and evolve with the user. Aspects of the present disclosure recognize that the user experience can be improved even further by enabling the VA system 200 to initiate conversations or other interactions with a user (rather than waiting for user inputs to trigger a response).

In some aspects, the VA system 200 may be configured to alert a user of upcoming appointments or various tasks to be completed by the user in the absence of any user input. For example, if a user's calendar or appointment book includes an appointment for guitar lessons, the VA system 200 may initiate a conversation notifying the user that “it is time to get ready for your guitar lessons” before the scheduled time, even if the user is not engaged with the VA system 200 at the time. In such aspects, the input sources 210 may include a virtual calendar or task scheduler that can be accessed via a network interface or API, and the input data 201 may include various calendar appointments or scheduled tasks to be completed by the user.

Aspects of the present disclosure further recognize that some modern NLPs are capable of processing prompts having multiple modalities. An example suitable multimodal prompt may include a user query, “What is that?” and an image of the user pointing to an object. Such multimodal prompts may provide additional dimensions of interaction between a virtual assistant and its users, allowing for more natural user engagement. Thus, in some aspects, the VA system 200 may be configured to support multiple modalities. In such aspects, the input sources 210 may include multiple sensor technologies (such as cameras and microphones), and the input data 201 may include multiple types of sensor data (such as audio signals and images or video). In some implementations, media content captured via one or more sensors (such as images, video, or audio) may be passed directly to the NLP. For example, such media content may be included in the user content 202 and the prompt 204.

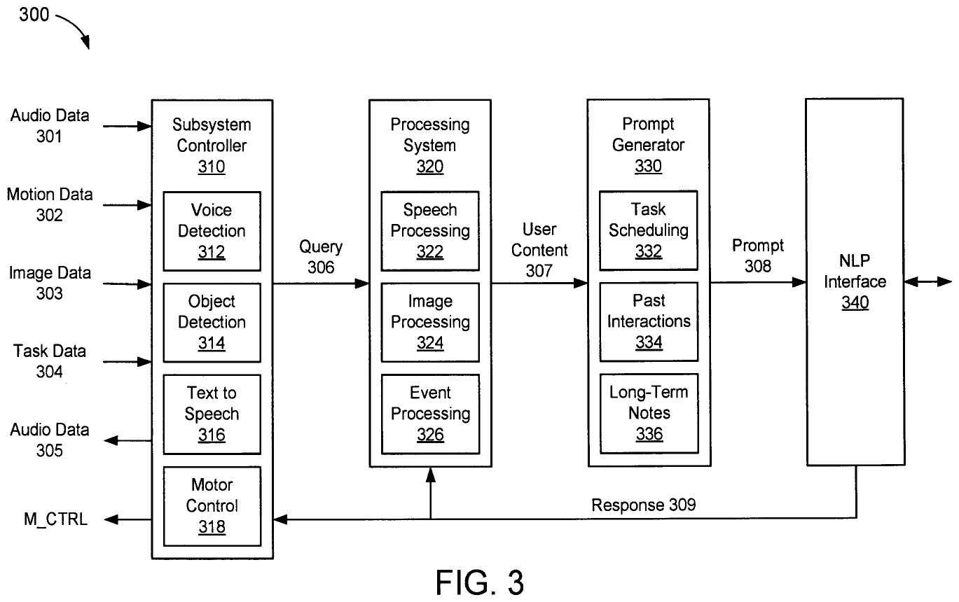

FIG. 3 shows another block diagram of an example VA system 300, according to some implementations. The VA system 300 is configured to assist a user with various tasks via hands-free operation, for example, by responding to the user's instructions or queries. More specifically, the VA system 300 may be configured to communicate with an NLP backend (not shown for simplicity) to determine the responses to the user instructions or queries. In some implementations, the VA system 300 may be one example of the VA system 200 of FIG. 2 or the virtual assistant 110 of FIG. 1.

The VA system 300 includes a subsystem controller 310, a processing system 320, a prompt generator 330, and an NLP interface 340. The subsystem controller 310 is configured to receive input data from various input sources (such as the input sources 210 of FIG. 2) and produce a query 306 based on the received input data. Example suitable input sources include microphones, cameras, motion sensors, and task schedulers, among other examples. In some implementations, the input sources may include different types of sensor technologies so that the input data has multiple modalities.

In the example of FIG. 3, the input data is shown to include audio data 301, motion data 302, image data 303, and task data 304. For example, the audio data 301 may include an audio signal captured via a microphone, the motion data 302 may be a binary signal indicating whether motion is detected by a motion sensor, the image data 303 may include an image or video frame captured by a camera, and the task data 304 may include a schedule of appointments or tasks associated with a task scheduler.

In some aspects, the subsystem controller 310 may generate the query 306 based on input data associated with user activity. Example suitable user activity may include user speech, user movements, or various tasks to be performed by a user. In some implementations, the subsystem controller 310 may detect user activity based, at least in part, on the motion data 302. In some other implementations, the subsystem controller 310 may include a voice detection component 312 configured to detect human voices (or speech) in the received audio data 301. For example, the voice detection component may be a voice activity detector (VAD) that can separate human speech from background noise (or other sources of audio).

Still further, in some implementations, the subsystem controller 310 may include an object detection component 314 configured to detect a presence or location of an object of interest (such as a person) in the received image data 303. For example, the object detection component 314 may infer one or more bounding boxes coinciding with locations of objects of interest based on an object detection model. In some implementations, the object detection component 314 may determine whether each detected object of interest matches a stored person identifier (ID). For example, each person ID may be associated with a registered user of the VA system 300.

The query 306 may include portions of any of the input data 301-304 associated with user activity. In some implementations, the query 306 may include portions of audio data 301 representing audio signals in which human speech is detected. In some other implementations, the query 306 may include portions of image data 303 representing images in which objects of interest are detected. In such implementations, the query 306 also may include one or more person IDs (if any) matching the detected objects of interest. Still further, in some implementations, the query 306 may include any task data 304 received from the task scheduler.

The processing system 320 is configured to produce user content 307 based on the query 306. More specifically, the processing system 320 may extract from the user content 307 information suitable for encoding as an NLP prompt. In some implementations, the processing system 320 may include a speech processing component 322 configured to perform a speech-to-text conversion operation that transcribes user speech in any audio data 301 associated with the query 306 into text. In some implementations, the speech processing component 322 may further determine whether the user speech matches a stored voice ID. For example, each voice ID may be associated with a registered user of the VA system 300.

In some implementations, the processing system 300 may include an image processing component 324 configured to infer contextual information about any image data 303 associated with the query 306. Example suitable contextual information may include, among other examples, information indicating where a user is looking, what a user is doing, or a presence of other known objects in the user's environment. In some other implementations, such contextual information may be inferred by the NLP backend (rather than the image processing component 324). In such implementations, the processing system 300 may forward the image data 303 associated with the query 306 to the NLP backend. For example, the image data 303 may be included in the user content 307 sent to the prompt generator 330, and the prompt generator 330 may further produce a prompt 308 that includes the image data 303.

In some implementations, the processing system 300 may include an event processing component 326 configured to extract relevant details and other information from any task data 304 associated with the query 306. Example suitable details may include dates, times, or locations associated with scheduled tasks or appointments, a number of tasks to be completed, a description of each task to be completed, and people or contacts associated with each task, among other examples. The user content 307 may include text or voice IDs extracted from the audio data 301, contextual information or person IDs extracted from the image data 303, event details extracted from the task data 304, or any combination thereof. In some implementations, the user content 307 also may include raw audio data 301 or image data 303 associated with the query 306.

The prompt generator 330 is configured to generate a prompt 308 based, at least in part, on the user content 307. In some implementations, the prompt generator 330 may be one example of the PPC component 240 of FIG. 2. For example, the prompt generator 330 may encode textual content associated with the user content 307 (such as text extracted from the audio data 301, contextual information extracted from the image data 303, or event details extracted from the task data 304) into a sequence of tokens to be included in the prompt 308. Alternatively, or in addition, the prompt generator 330 may encode previously stored information into the prompt 308. For example, the prompt generator 330 may include a memory that can store information associated with previous input data received by the subsystem controller 310.

In some implementations, the prompt generator 330 may be configured to store task scheduling information 332 indicating various tasks to be completed by a user or other information associated therewith. For example, the prompt generator 330 may store any portion of the user content 307 derived from the task data 304 so that the VA system 300 can remind the user of any upcoming tasks on the user's calendar. In some implementations, the task scheduling information 332 may include customizable task details that are not included in the task data 304. Example customizable task details may include the morning news, a preset radio station to be used as an alarm, or a daily weather report for the user's location, among other examples.

In some other implementations, the prompt generator 330 may be configured to store one or more past interactions 334 between the VA system 300 and a user. The past interactions 334 may include one or more prompts 308 previously transmitted to the NLP backend, one or more responses 309 previously received from the NLP backend, or any combination thereof. For example, the prompt generator 330 may extract embeddings from a threshold number of previous prompts 308 and a threshold number of previous responses 309 and may store the embeddings in memory. In some implementations, the prompt generator 330 may store the embeddings, together with any associated text, in a searchable database.

Still further, in some implementations, the prompt generator 330 may be configured to store long-term notes 336 based on past interactions between the VA system 300 and a user. For example, when a current interaction between the VA system 300 and the user reaches a token limit associated with the NLP backend (such as a maximum number of tokens that can be shared between a prompt 308 and a response 309), the prompt generator 330 may summarize the current interaction into long-term notes 336. The long-term notes 336 may include any information that can be extracted from a history of past interactions (since initialization of the VA system 300) and used to personalize the prompt 306 for the particular user.

In some implementations, the long-term notes 336 may include one or more personality traits adopted by the VA system 300 (such as described with reference to FIG. 2). In some other implementations, the long-term notes 336 may include personal information about the user. Example personal information about the user may include, among other examples, the user's favorite sports, hobbies, movies, music, food, and various other interests learned about the user. In some other implementations, the long-term notes 336 may include personal information about the VA system 300. Example personal information about the VA system 300 may include, among other examples, the virtual assistant's favorite sports, hobbies, movies, music, food, and various other interests attributed to the VA system 300 (such as by a user).

In some aspects, the prompt generator 330 may determine which (if any) of the stored information to include in the prompt 308 based on a voice ID or a person ID included in the user content 307. For example, the information stored by the prompt generator 330 may be indexed or otherwise associated with a user's voice ID or person ID. Thus, the prompt 308 may include a tokenized representation of any textual content included in the user content 307 as well as any task scheduling information 332, past interactions 334, or long-term notes 336 that matches a voice ID or a person ID included in the user content 307. In some implementations, the prompt generator 330 may further map the tokens to word embeddings as part of the prompt encoding process. In some implementations, the prompt 308 may include media content (such as audio data 301 or image data 303) associated with the user content 307. For example, the prompt generator 330 may forward such media content to the NLP to infer contextual information about the user or the environment.

The NLP interface 340 is configured to transmit the prompt 308 to the NLP backend. In some implementations, the NLP interface 340 may be one example of the NLP interface 260 of FIG. 2. For example, the NLP interface 340 may include an API associated with the NLP backend or communications hardware that can transmit the prompt 308 to the NLP backend. The NLP backend may be any suitable NLP configured to generate a response 309 based on the prompt 308. In some implementations, the NLP backend may be one example of the NLP 120 of FIG. 1. The NLP interface 340 is further configured to receive the response 309 from the NLP backend and provide the response to the subsystem controller 310.

The subsystem controller 310 is further configured to produce output data based on the received response 309. In the example of FIG. 3, the output data is shown to include audio data 305. In some implementations, the subsystem controller 310 may include a text to speech component 316 configured to decode or recover textual content included in the response 309 and perform a text-to-speech conversion operation that converts the decoded text to the audio data 305. For example, the audio data 305 may represent an audio signal that can be provided to one or more speakers (not shown for simplicity) for output to the user.

In some implementations, the VA system 300 may be disposed within a physical device (such as a children's toy or other housing design) that includes the various sensors and speakers. For example, the physical device may be specifically referred to as the “virtual assistant.” In some other implementations, the subsystem controller 310 may be the only component of the VA system 300 that is disposed within the virtual assistant (together with the various sensors and speakers). In such implementations, the processing system 320 and the prompt generator 330 may be hosted on a server that is external to the virtual assistant.

Aspects of the present disclosure recognize that some NLPs can generate instructions or commands based on prompts received as inputs. Example suitable instructions may include instructions to perform a motorized function (such as following a user), register a new user, perform an Internet search, add items to a shopping list, and perform additional processing operations, among other examples. With reference for example to FIG. 3, if a prompt 308 includes the phrase, “my name is John,” the NLP backend may produce a response 309 that includes instructions to “REGISTER SPEAKER AS JOHN” or “REGISTER FACE AS JOHN.” In response to receiving such instructions from the NLP backend, the VA system 300 may register a new voice ID or person ID based on the speech or face, respectively, of the user associated with the prompt 308.

In some implementations, the VA system 300 may recurrently (or automatically) generate new prompts 308 based on processing instructions included in the response 309 received from the NLP. In such implementations, the response 309 may be provided as an input to the processing system 320 (or the prompt generator 330), for example, in a feedback loop. In some other implementations, the VA system 300 may move or otherwise perform one or more motorized functions based on instructions included in the response 309. In such implementations, the subsystem controller 310 may include a motor control component 318 configured to control one or more motors (not shown for simplicity) disposed on or otherwise associated with the VA system 300. For example, the motor control component 318 may produce one or more control signals (M_CTRL) that can be used to control an operation of the motors based on the response 309 received from the NLP.

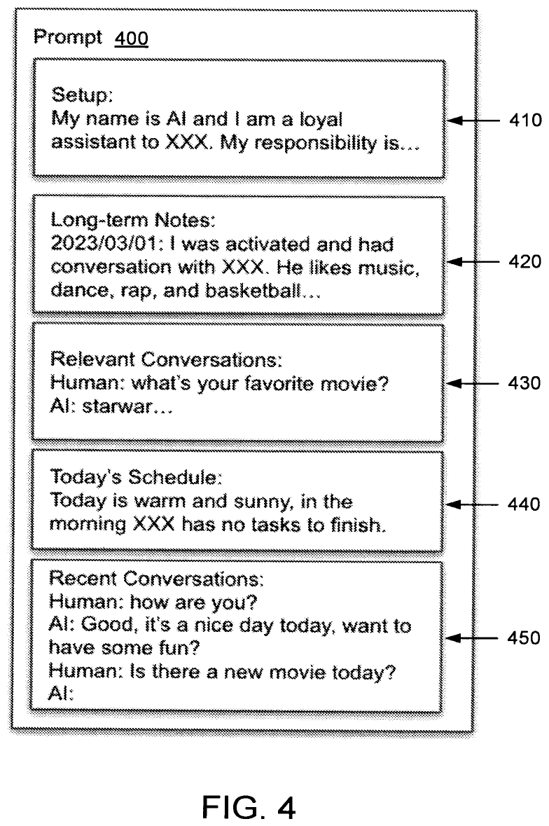

FIG. 4 shows an example natural language processing prompt 400, according to some implementations. The prompt 400 may be generated by a virtual assistant (such as the virtual assistant 110 of FIG. 1 or any of the VA systems 200 or 300 of FIGS. 2 and 3, respectively) and provided as input to an NLP for purposes of inferring a response. In some implementations, the prompt 400 may be one example of any of the prompts 103, 204, or 308 of FIGS. 1, 2, and 3, respectively. In the example of FIG. 4, the prompt 400 is shown to include setup information 410, long-term notes 420, relevant conversations 430, scheduling information 440, and recent conversations 450.

The setup information 410 indicates how the virtual assistant is configured to operate for a registered user. Example suitable setup information 410 may include the name of the registered user, a name assigned to the virtual assistant, and one or more responsibilities assigned to the virtual assistant, among other examples. With reference for example to FIG. 3, the prompt generator 330 may store the setup information 410 during an initialization of the virtual assistant or when the user is registered with the virtual assistant. More specifically, the setup information 410 may be associated with the registered user's voice ID or person ID. The prompt generator 330 may select the setup information 410 to be included in the prompt 400 based on a matching voice ID or person ID detected in the user content 307.

The long-term notes 420 include information derived from a history of past interactions between the virtual assistant and the registered user. In some implementations, the long-term notes 420 may be one example of any of the long-term notes 252 or 336 of FIGS. 2 and 3, respectively. For example, the long-term notes 420 may include one or more personality traits adopted by the virtual assistant, personal information about the registered user, or personal information about the virtual assistant itself (such as described with reference to FIGS. 2 and 3). The long-term notes 420 may be associated with the registered user's voice ID or person ID. With reference for example to FIG. 3, the prompt generator 330 may select the long-term notes 420 to be included in the prompt 400 based on a matching voice ID or person ID detected in the user content 307.

The relevant conversations 430 include one or more past queries or responses that are related to the current query. In some implementations, the relevant conversations 430 may include one or more of the past interactions 334 of FIG. 3. For example, the relevant conversations 430 may include previous prompts or responses stored in a database associated with the registered user's voice ID or person ID. With reference for example to FIG. 3, the prompt generator 330 may select the relevant conversations 430 to be included in the prompt 400 based on a matching voice ID or person ID detected in the user content 307. More specifically, the prompt generator 330 may search the database associated with the registered user's voice ID or person ID for embeddings that match the user content 307 and may select the prompts and responses associated with the closest matches.

The scheduling information 440 includes one or more tasks or to be completed by the registered user or other information associated therewith. In some implementations, the scheduling information 440 may be one example of the task data 304 of FIG. 3. In some other implementations, the scheduling information may be one example of the task scheduling information 332 of FIG. 3. For example, the scheduling information 440 may include customizable task details that are not included in the task data 304 (such as described with reference to FIG. 3). The scheduling information 440 may be associated with the registered user's voice ID or person ID. With reference for example to FIG. 3, the prompt generator 330 may select the scheduling information 440 to be included in the prompt 400 based on a matching voice ID or person ID detected in the user content 307.

The recent conversations 450 include one or more recent queries or responses processed by the virtual assistant. In some implementations, the recent conversations 450 may include one or more of the past interactions 334 of FIG. 3. For example, the recent conversations 450 may include a threshold number (N) of previous prompts or a threshold number (N) of previous responses stored in a database associated with the registered user's voice ID or person ID. With reference for example to FIG. 3, the prompt generator 330 may select the recent conversations 450 to be included in the prompt 400 based on a matching voice ID or person ID detected in the user content 307. More specifically, the prompt generator 330 may select the N most recent prompts and the N most recent responses in the database associated with the registered user's voice ID or person ID.

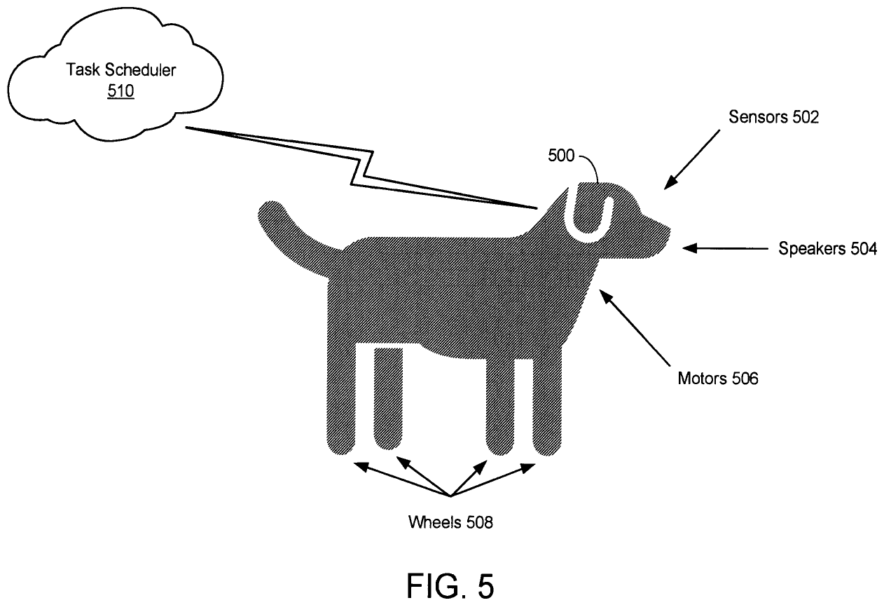

FIG. 5 shows an example implementation of a virtual assistant 500 with adaptive personality traits, according to some implementations. The virtual assistant 500 is configured to assist a user with various tasks via hands-free operation, for example, by responding to the user's instructions or queries. More specifically, the virtual assistant 500 may be configured to communicate with an NLP backend (not shown for simplicity) to determine the responses to the user instructions or queries. In some implementations, the virtual assistant 500 may be one example of the virtual assistant 100 of FIG. 1 or any of the VA systems 200 or 300 of FIGS. 2 and 3, respectively.

The virtual assistant 500 includes one or more sensors 502, one or more speakers 504, one or more motors 506, and a number of wheels 508. In the example of FIG. 5, the virtual assistant 500 is disposed within a children's toy (in the general shape of a dog). However, in actual implementations, the virtual assistant 500 may be embodied within any physical device or housing. With reference for example to FIG. 2, the sensors 502 may be one example of the input sources 210 and the speakers 504 may be one example of any of the output sources 220. For example, the sensors 502 may be configured to detect changes in the surrounding environment and the speakers 504 may be configured to output audio in response to the detected changes (such as described with reference to FIGS. 1-3). In some implementations, the virtual assistant 500 also may receive input data via a task scheduler 510.

The motors 506 are configured to position (or reposition) the sensors 502 based, at least in part, on changes detected in the environment. For example, as shown in FIG. 5, the sensors 502 may be disposed in the dog's head and the motors 506 may be disposed in the dog's neck. With reference for example to FIG. 3, the object detection component 314 may be configured to infer bounding boxes that coincide with the locations of objects of interest (such as user faces) detected in the image data 303. In some implementations, the motor control component 318 may control a movement of the motors 506 based on the bounding boxes. For example, the motor control component 318 may operate the motors 506, using the control signals M_CTRL, to turn or tilt the dog's head so that the sensors 502 track the movements of the user. As such, the virtual assistant 500 may ensure that the user remains in the field-of-view (FOV) of its cameras.

The wheels are configured to propel the virtual assistant 500 based, at least in part, on changes detected in the environment. For example, as shown in FIG. 5, the wheels 508 may be disposed in the dog's legs or feet and may be driven by one or more motors (not shown for simplicity). In the example of FIG. 5, the virtual assistant 500 is shown to include four wheels 508. However, in actual implementations, the virtual assistant 500 may include any number of wheels or various other means of propulsion. With reference for example to FIG. 3, if a prompt 308 includes the phrase, “follow me,” the NLP backend may produce a response 309 that includes instructions to “FOLLOW PERSON X,” where Person X is the person ID associated with the prompt 308. In response to receiving such instructions from the NLP backend, the motor control component 318 may operate the wheels 508, using the control signals M_CTRL, so that the virtual assistant 500 follows the movements of the user.

For example, while maintaining Person X in the FOV of its cameras (such as via the motors 506), the virtual assistant 500 may further maintain a threshold distance to Person X. In some implementations, the sensors 502 may include one or more depth sensing technologies that can be used to determine the distance of Person X. Example suitable depth sensing technologies include radio detection and ranging (RADAR) and light detection and ranging (LiDAR), among other examples. In some other implementations, the subsystem controller 310 may estimate the distance of Person X based on images captured by a monocular camera (such as based on the bounding boxes inferred by the object detection component 314). If a subsequent prompt 308 includes the phrase, “stop following me,” the NLP backend my produce a response 309 that includes instructions to “STOP FOLLOWING PERSON X.” In response thereto, the motor control component 318 may stop or suspend any subsequent operation of the wheels 508.

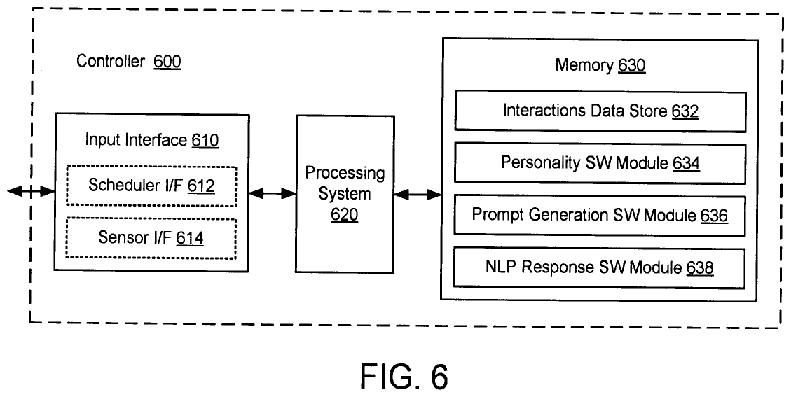

FIG. 6 shows another block diagram of an example controller for a VA system 600, according to some implementations. In some implementations, the VA system may be one example of any of the VA system 200 or 300 of FIGS. 2 and 3, respectively.

The controller 600 includes an input interface 610, a processing system 620, and a memory 630. The input interface 610 is configured to communicate with one or more input sources associated with the controller 600. In some implementations, the input interface 610 may include a scheduler interface (I/F) 612 and a sensor interface (I/F) 614. The scheduler I/F 612 is configured to communicate with a task scheduler. The sensor I/F 614 is configured to communicate with one or more sensors (such as cameras, microphones, or motion sensors). In some implementations, the input interface 610 may receive input data via the one or more input sources.

The memory 630 may include an interactions data store 632 configured to store a history of interactions between the controller 600 and a user (such as the memory 250 of FIG. 2). The memory 630 also may include a non-transitory computer-readable medium (including one or more nonvolatile memory elements, such as EPROM, EEPROM, Flash memory, or a hard drive, among other examples) that may store at least the following software (SW) modules:
a personality SW module 634 to assign a set of personality traits to the VA system based on one or more interactions between the VA system and a user;
a prompt generation SW module 636 to generate a prompt based at least in part on the received input data and the set of personality traits assigned to the VA system; and
an NLP response SW module 638 to infer a response to the prompt based on an NLP model.
   Each software module includes instructions that, when executed by the processing system 620, causes the controller 600 to perform the corresponding functions.

The processing system 620 may include any suitable one or more processors capable of executing scripts or instructions of one or more software programs stored in the controller 600 (such as in the memory 630). For example, the processing system 620 may execute the personality SW module 634 to assign a set of personality traits to the VA system based on one or more interactions between the VA system and a user. The processing system 620 also may execute the prompt generation SW module 636 to generate a prompt based at least in part on the received input data and the set of personality traits assigned to the VA system. Further, the processing system 620 may execute the NLP response SW module 638 to infer a response to the prompt based on an NLP model.

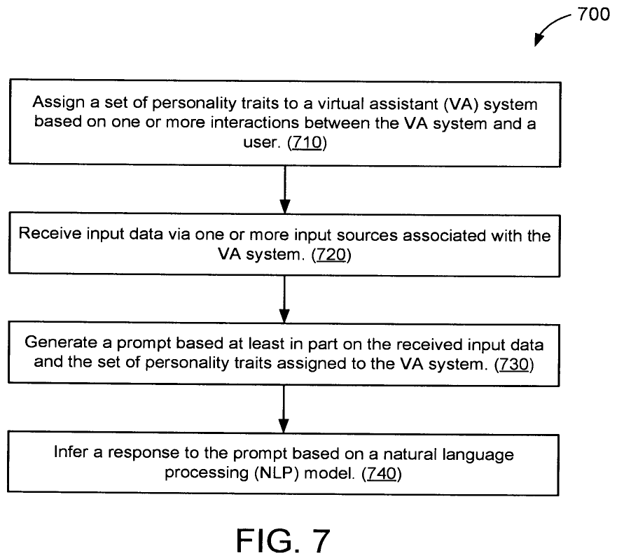

FIG. 7 shows an illustrative flowchart 700 depicting an example operation performed by a controller for a VA system, according to some implementations. In some implementations, the example operation 700 may be performed by the controller 600 of FIG. 6.

The controller assigns a set of personality traits to the VA system based on one or more interactions between the VA system and a user (610). The controller receives input data via one or more input sources associated with the VA system (620). The controller generates a prompt based at least in part on the received input data and the set of personality traits assigned to the VA system (630). The controller infers a response to the prompt based on an NLP model (640).

In some aspects, the set of personality traits may be associated with one or more characteristics of the response. In some implementations, the one or more characteristics may include a conciseness of the response. In some implementations, the controller may further update the set of personality traits based on the response.

In some implementations, the controller may further store a set of long-term notes associated with past interactions between the VA system and the user and update the set of long-term notes based on the received input data and the response, where the prompt is further generated based on the set of long-term notes.

In some implementations, the controller may further determine one or more relevant interactions based on the received input data and search a set of past interactions between the VA system and the user for the one or more relevant interactions, where the prompt is further generated based on the one or more relevant interactions.

In some implementations, the prompt may be further generated based on a schedule of tasks to be completed by the user and absent any input from the user.

In some implementations, the input data may include audio receive via a microphone. In such implementations, the controller may further detect speech in the received audio, determine that the speech matches a voice ID associated with the user, and convert the speech to text, where the prompt being is generated based on the voice ID and the text converted from the speech.

In some implementations, the input data may include an image received via a camera. In such implementations, the controller may further detect an object of interest in the received image, determine that the object of interest matches a person ID associated with the user, and infer contextual information associated with the object of interest based on the NLP model, where the prompt is further generated based on the person ID and the contextual information.

In some implementations, the controller may further detect movements of the user based on the received input data and adjust a position of at least one of the one or more input sources based on the detected movements.

In some implementations, the received input data may include a command to follow the user and the response may cause the VA system to activate one or more motors that propel the one or more input sources in a direction of the user.

In some implementations, the response may include a text completion associated with the prompt. In such implementations, the controller may further convert the text completion to speech and output the speech via a speaker associated with the VA system.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method performed by a controller for a virtual assistant (VA) system, comprising:
assigning a set of personality traits to the VA system based on one or more interactions between the VA system and a user;
receiving input data via one or more input sources associated with the VA system;
generating a prompt based at least in part on the received input data and the set of personality traits assigned to the VA system; and
inferring a response to the prompt based on a natural language processing (NLP) model.

2. The method of claim 1, wherein the set of personality traits is associated with one or more characteristics of the response.

3. The method of claim 2, wherein the one or more characteristics include a conciseness of the response.

4. The method of claim 1, further comprising:
updating the set of personality traits based on the response.

5. The method of claim 1, further comprising:
storing a set of long-term notes associated with past interactions between the VA system and the user, the prompt being further generated based on the set of long-term notes; and
updating the set of long-term notes based on the received input data and the response.

6. The method of claim 1, further comprising:
determining one or more relevant interactions based on the received input data; and
searching a set of past interactions between the VA system and the user for the one or more relevant interactions, the prompt being further generated based on the one or more relevant interactions.

7. The method of claim 1, wherein the prompt is further generated based on a schedule of tasks to be completed by the user and absent any input from the user.

8. The method of claim 1, wherein the input data includes audio received via a microphone, the method further comprising:
detecting speech in the received audio;
determining that the speech matches a voice identifier (ID) associated with the user; and
converting the speech to text, the prompt being further generated based on the voice ID and the text converted from the speech.

9. The method of claim 1, wherein the input data includes an image received via a camera, the method further comprising:
detecting an object of interest in the received image;
determining that the object of interest matches a person identifier (ID) associated with the user; and
inferring contextual information associated with the object of interest based on the NLP model, the prompt being further generated based on the person ID and the contextual information.

10. The method of claim 1, further comprising:
detecting movements of the user based on the received input data; and
adjusting a position of at least one of the one or more input sources based on the detected movements.

11. The method of claim 1, wherein the received input data includes a command to follow the user and the response causes the VA system to activate one or more motors that propel the one or more input sources in a direction of the user.

12. The method of claim 1, wherein the response includes a text completion associated with the prompt, the method further comprising:
converting the text completion to speech; and
outputting the speech via a speaker associated with the VA system.

13. A controller for a virtual assistant (VA) system, comprising:
a processing system; and
a memory storing instructions that, when executed by the processing system, causes the controller to:
assign a set of personality traits to the VA system based on one or more interactions between the VA system and a user;
receive input data via one or more input sources associated with the VA system;
generate a prompt based at least in part on the received input data and the set of personality traits assigned to the VA system; and
infer a response to the prompt based on a natural language processing (NLP) model.

14. The controller of claim 12, wherein the set of personality traits is associated with one or more characteristics of the response.

15. The controller of claim 12, wherein execution of the instructions further causes the VA system to:
store a set of long-term notes associated with past interactions between the VA system and the user, the prompt being further generated based on the set of long-term notes; and
update the set of long-term notes based on the received input data and the response.

16. The controller of claim 12, wherein execution of the instructions further causes the VA system to:
determine one or more relevant interactions based on the received input data; and
search a set of past interactions between the VA system and the user for the one or more relevant interactions, the prompt being further generated based on the one or more relevant interactions.

17. The controller of claim 12, wherein the prompt is further generated based on a schedule of tasks to be completed by the user and absent any input from the user.

18. The controller of claim 12, wherein the input data includes audio received via a microphone, execution of the instructions further causing the VA system to:
detect speech in the received audio;
determine that the speech matches a voice identifier (ID) associated with the user; and
convert the speech to text, the prompt being further generated based on the voice ID and the text converted from the speech.

19. The controller of claim 12, wherein the input data includes an image received via a camera, execution of the instructions further causing the VA system to:
detect an object of interest in the received image;
determine that the object of interest matches a person identifier (ID) associated with the user; and
infer contextual information associated with the object of interest based on the NLP model, the prompt being further generated based on the person ID and the contextual information.

20. The controller of claim 12, wherein execution of the instructions further causes the VA system to:
detect movements of the user based on the received input data; and
adjust a position of at least one of the one or more input sources based on the detected movements.
